(19) United States
(12) Patent Application Publication
(10) Pub. No.: US 2007/0030814 A1
(43) Pub. Date: Feb. 8, 2007

(54) Memory module and method thereof

(75) Inventors: Seung-Man Shin, Suwon-si (KR); Hui-Chong Shin, Seongnam-si (KR); Jong-Geon Lee, Seoul (KR); Kyung-Hee Han, Gwangmyeong-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/489,446

(22) Filed: Jul. 20, 2006

(30) Foreign Application Priority Data
Aug. 4, 2005 (KR) 10-2005-0071198

(51) Int. Cl. H04L 12/26

(52) U.S. Cl. 370/241; 365/201

(57) ABSTRACT

A memory module and method thereof are provided. In the example method, a test signal may be applied to a plurality of memory chips included in the memory module. Output data from the plurality of memory chips may be received in response to the applied test signal. The received, output data may be divided into a plurality of groups. At least one of the plurality of groups may be selected in response to an output group selection signal. The at least one selected group may be output (e.g., to an external device). The example memory module may include a plurality of chips and a hub. The example memory module may be configured to perform the above-described example method.

### PRIORITY STATEMENT

This application claims priority under 35 U.S.C. § 119 to Korean Patent Application No. 2005-71198 filed on Aug. 4, 2005, the contents of which are herein incorporated by reference in its entirety.

### BACKGROUND OF THE INVENTION

1. Field of the Invention

Example embodiments of the present invention relate generally to a memory module and method thereof, and more particularly to a memory module and method of testing the memory module.

2. Description of the Related Art

Memory chips, such as dynamic random-access memory (DRAM) chips, may be installed in a computer system in the form of memory modules. Each memory module may include a plurality of the memory chips mounted on a printed circuit board (PCB).

Memory modules may typically be as one of a classified single inline memory module (SIMM) or a dual inline memory module (DIMM). Memory chips may be mounted on one side of a PCB in the SIMM and memory chips may be mounted on both sides of a PCB in the DIMM. Because DIMMs may include more memory chips than SIMMs, a DIMM may be relatively more efficient (e.g., a higher memory capacity to occupied space ratio) than a SIMM.

A fully buffered DIMM (FBDIMM) may be a type of DIMM used in higher-speed operations operating in accordance with packet protocols and, typically, higher memory capacities. Unlike other DIMMs, the FBDIMM may include a hub for converting a packet-type serial interface to a DRAM interface.

A hub may refer to an advanced memory buffer (AMB) chip that may convert a higher-speed packet applied from a host, such as a microprocessor, to a memory command. The hub may function as an interface for transmitted and/or received signals.

FIG. 1 is a block diagram illustrating a configuration of a memory system including a conventional FBDIMM.

Referring to FIG. 1, the memory system may include a host 10 and a plurality of memory modules 20 and 30 connected in a daisy chain. To simplify the description of FIG. 1, first and second memory modules 20 and 30 are illustrated in FIG. 1, while it is understood that the memory system of FIG. 1 may include additional memory modules (not shown) (e.g., up to eight memory modules may be connected to the memory system of FIG. 1).

Referring to FIG. 1, the memory modules 20 and 30 may include hubs 21 and 31, respectively, and a plurality of memory chips 22 through 29 and 32 through 39, respectively. As shown in FIG. 1, eight of the memory chips (i.e., memory chips 22 through 29 and 32 through 39) may be connected per memory module (i.e., memory modules 20 and 30). In an example, a total of nine memory chips (e.g., the eight illustrated memory chips 22 through 29 or 32 through 39 plus an additional memory chip performing an error correction code (ECC)) may be connected per memory module

Referring to FIG. 1, the host 10 may transmit a higher-speed southbound SB packet to the plurality of the memory modules 20 and 30 through the daisy chain. The southbound packet may include information, such as an address ADD, a memory command CMD and write data Wdata. The southbound packet may be transmitted to the first hub 21 of the first memory module 20. Alternatively, the southbound packet may bypass the first hub 21 to be transmitted directly to the second hub 31.

Referring to FIG. 1, the southbound packet may include a DIMM recognition code. Each of the memory modules 20 and 30 may identify the DIMM recognition code of the southbound packet to selectively process information (e.g., information addressed to one or more of the memory modules 20 and/or 30) included in the southbound packet.

For example, the first memory module 20 may extract information included in the southbound packet (e.g., information to be transmitted to one or more of the memory chips 22 through 29) if the DIMM recognition code included in the southbound packet identifies a DIMM recognition code included in the first memory module 20. Alternatively, the first memory module 20 may bypass the received southbound packet, and may instead transfer the received southbound packet to the second memory module 30 without extracting information if the DIMM recognition code included in the southbound packet does not identify a DIMM recognition code included in the first memory module 20.

Referring to FIG. 1, the first hub 21 of the first memory module 20 may process the received southbound packet to transmit a plurality of signals, such as a data input/output DQ, an address/command ADDR/CMD and a memory clock CLK, to the memory chips 22 through 29. In addition, each of the hubs 21 and 31 may be connected to a System Management Bus (SMBUS) to receive an operation control signal.

Referring to FIG. 1, the above-described southbound packet may be inputted to a southbound reception port SRx of each of the hubs 21 and 31, and may be outputted through a southbound transmission port STx. The outputted southbound packet may be transferred to a southbound reception port SRx of the second hub 31 of the second memory module 30, and may be outputted through a southbound transmission port STx of the second hub. During a single cycle of a reference clock (e.g., transmitted through a separate transmission line), the southbound packet may be transmitted to all hubs (e.g., hubs 21, 31, etc.) of the memory system.

Referring to FIG. 1, the memory system may sequentially write data to each of the memory modules 20 and 30. In other words, after a write operation of data to the first memory module 20 is complete, a write operation of data to the second memory module 30 may be initiated, thereby generating a “sequential” data write operation (e.g., non-concurrent write operations).

Referring to FIG. 1, the southbound packet transmitted from the host to the first memory module 20 may be referred to as a primary southbound packet, and the southbound packet transmitted from the first memory module 20 to a subordinate memory module, such as the second memory module 30, may be referred to as a secondary southbound packet.

Referring to FIG. 1, data being outputted from the memory chips 22 through 29 and 32 through 39 may be transmitted to the host 10 through the daisy chain. The output data may be transmitted as a packet, and may be referred to as a northbound NB packet. Read data transmitted from the memory chips 22 through 29 to the hub 21 may be packetized in the hub 21, and may be outputted through a northbound transmission port NTx. In addition, an outputted write data packet may be received through a northbound reception port NRx of an adjacent memory module, and then may be transmitted to the host through a sequential transmission process.

Referring to FIG. 1, the northbound packet, transmitted from the first memory module 20 to the host 10, may be referred to as a primary northbound packet, and the northbound packet, transmitted from the subordinate memory module (e.g., such as the second memory module 30) to the first memory module 20, may be referred to as a secondary northbound packet.

Referring to FIG. 1, a propagation delay of the southbound packet and the northbound packet between the host 10 and the hubs 21/31 may be lower than a propagation delay of the southbound/northbound packet between the hubs 21/31 and the memory chips 22 through 29 and/or 32 through 39 (e.g., up to six times faster). Thus, an interface between the host 10 and the hubs 21/31 may be faster than an interface between the hubs 21/31 and the memory chips 22 through 29 and/or 32 through 39.

Therefore, if the first and/or second memory module 20/30 is tested, higher-speed test equipment may be connected to the higher-speed interface between the host 10 and the hub 21/31. However, if the higher-speed test equipment detects a defect in a tested memory module, it may be difficult to determine whether the defect has occurred in one of the hubs 21/31 or within the memory chips 22 through 29 and/or 32 through 39.

A Design-For-Test (DFT) function may be deployed within a hub of a memory module. The DFT function may be a mode for facilitating a test of the memory module (e.g., such as a FBDIMM). The DFT function may correspond to any of a number of modes, such as an Interconnect Built-in Self-Test (IBIST mode, a Memory Software Implemented Self-Test (MSIST) mode, a transparent mode, etc. In the transparent mode, the hub may be bypassed during the test of the memory module. As used herein, the hub may be “bypassed” in the sense that a higher-speed interface block of the hub may be bypassed during the test, while the hub may not be bypassed physically from an external viewpoint.

In the transparent mode, functions of higher-speed pins, included within the southbound transmission port STx, the southbound reception port SRx, the northbound transmission port NTx and the northbound reception port NRx for the transmission and the reception of the southbound packet and the northbound packet, may be substituted with functions of pins for directly accessing the memory.

FIG. 2 is a table illustrating a number of channels of the conventional FBDIMM for transmission and reception of a higher-speed signal.

As shown in the table of FIG. 2, the memory module (i.e., the FBDIMM) may include 96 channels. The 96 channels may include 48 transmission channels and 48 reception channels. The 48 reception/transmission channels may each include 24 negative channels and 24 positive channels. The southbound reception port SRx may include 20 channels (i.e., 10 positive channels and 10 negative channels). The southbound transmission port STx may also include 20 channels (i.e., 10 positive channels and 10 negative channels). The northbound reception port NRx may include 28 channels (i.e., 14 positive channels and 14 negative channels). The northbound transmission port NTx may include 28 channels (i.e., 14 positive channels and 14 negative channels).

Referring to FIG. 2, the higher-speed signal channels may be used as channels for the memory test in the transparent mode. That is, higher-speed signal pins may be mapped to memory pins during the memory test.

FIG. 3 is a table showing pin mappings of DRAM signals and higher-speed signals conforming to conventional Joint Electron Device Engineering Council (JEDEC) standards.

Referring to the table of FIG. 3, higher-speed signals may be configured to correspond to DRAM signals in the transparent mode. Here, SN*P may refer to a positive secondary northbound signal, and SN*N may refer to a negative secondary northbound signal. PS*P may refer to a positive primary southbound signal, and PS*N may refer to a negative primary southbound signal. SS*P may refer to a positive secondary southbound signal, and PN*P may refer to a positive primary northbound signal. As used above, the “*” may refer to a number of channels minus one, such that “*” may be an integer greater than or equal to zero.

Referring to FIG. 3, the reception channel of the higher-speed signal may be used as an input channel of a memory, and the transmission channel of the higher-speed signal may be used as an output channel of a memory. Because the DQ may be inputted to the AMB of the hub through different input and output paths in the transparent mode, and a differential output buffer may be shared (e.g., for data output), the number of channels that may be used for the output of the data may be limited to that of the positive channels (i.e., 24).

However, because an input/output (IO) of the FBDIMM may include 72 DQ pins (e.g., 8 DQ pins per memory chip×9 memory chips) and 18 data 10 strobe DQS pins (e.g., up to 2 DQS pins per memory chip×9 memory chips), the entire 10 may not be capable of concurrently testing the 72 DQ pins and 18 DQS pins through the 24 channels.

Therefore, the data 10 may be selected using the SMBUS in the transparent mode. Thus, the 10 of the memory module to be tested may be selected using the SMBUS prior to the test, and a DRAM cell may then be tested after performing a power-up sequence of the corresponding DRAM.

FIG. 4 is a flow chart illustrating a transparent mode test process using a conventional SMBUS. In particular, FIG. 4 illustrates a transparent mode test testing 72 DQ pins of a memory module.

Referring to FIG. 4, a first DQ group G1 to be tested (e.g., DQ0 through DQ23) may be selected using the SMBUS (at S1), an initialization of the DRAM may be performed (at S2), and a test of the corresponding first group may be carried out (at S3). Thereafter, a second DQ group G2 (e.g., DQ24 through DQ47) may be selected (at S4), the initialization of the DRAM may be performed (at S5), and a test of the corresponding second group may be carried out (at S6). Then, a third DQ group G3 (e.g., DQ48 through DQ71) may be selected (at S7), the initialization of the DRAM may be performed (at S8), and a test of the corresponding third group may be carried out (at S9).

Accordingly, as shown in FIG. 4, if a conventional memory module test is performed using the transparent mode, a plurality of tests (e.g., three tests in the process of FIG. 4) may be performed even if only one of the plurality of selectable DQ groups are scheduled for a memory test. Thus, a test time for memory pins may be extended due to the multiple tests, thereby reducing an efficiency of conventional transparent mode memory tests.

### SUMMARY OF THE INVENTION

An example embodiment of the present invention is directed to a memory module, including a plurality of memory chips and a hub applying a test signal to the plurality of memory chips included in the memory module, receiving output data from the plurality of memory chips in response to the applied test signal, dividing the output data into a plurality of groups, selecting at least one of the plurality of groups in response to an output group selection signal and outputting the at least one selected group.

Another example embodiment of the present invention is directed to a method for testing a memory module, including applying a test signal to a plurality of memory chips included in the memory module, receiving output data from the plurality of memory chips in response to the applied test signal, dividing the output data into a plurality of groups, selecting at least one of the plurality of groups in response to an output group selection signal and outputting the at least one selected group.

Another example embodiment of the present invention is directed to a memory module in which an output data group to be tested is efficiently selected during a test using a transparent mode.

In addition, example embodiments of the present invention provide a method for testing a memory module in which a test may be efficiently carried out using the memory module.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention.

FIG. 1 is a block diagram illustrating a configuration of a memory system including a conventional fully buffered DIMM (FBDIMM);

FIG. 2 is a table illustrating a number of channels of the conventional FBDIMM for transmission and reception of a higher-speed signal.

FIG. 3 is a table showing pin mappings of DRAM signals and higher-speed signals conforming to conventional Joint Electron Device Engineering Council (JEDEC) standards.

FIG. 4 is a flow chart illustrating a transparent mode test process using a conventional System Management Bus (SMBUS);

FIG. 5 is a block diagram illustrating a configuration of a memory module in accordance with an example embodiment of the present invention;

FIG. 6 is a flow chart illustrating a process for testing a memory module in accordance with another example embodiment of the present invention;

FIG. 7 is a table illustrating an output group selected according to an output group selection signal according to another example embodiment of the present invention;

FIG. 8 is a table illustrating an output group selected according to an output group selection signal received from an external device according to another example embodiment of the present invention;

FIG. 9 is a table illustrating DQS signals tested using an SMBUS according to another example embodiment of the present invention.

FIG. 10 is a timing diagram of signals during a memory test performed in accordance with the example embodiments of FIGS. 8 and 9.

### DETAILED DESCRIPTION OF EXAMPLE EMBODIMENTS OF THE PRESENT INVENTION

Hereinafter, example embodiments of the present invention will be explained in detail with reference to the accompanying drawings.

It will be understood that, although the terms first, second, etc., may be used herein to describe various elements, these elements should not be limited by these terms. These terms are used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular example embodiments and is not intended to be limiting of the invention. As used herein, the singular forms “a,” “an” and “the” are intended to include the plural forms as well, unless the context clearly indicates otherwise. It will be further understood that the terms “comprises,” “comprising” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

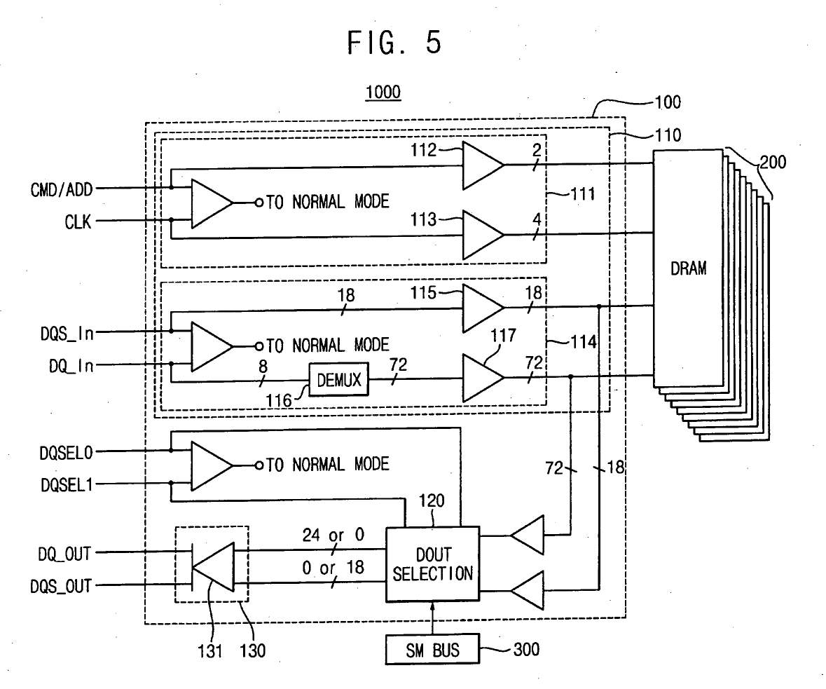

FIG. 5 is a block diagram illustrating a configuration of a memory module 1000 in accordance with an example embodiment of the present invention.

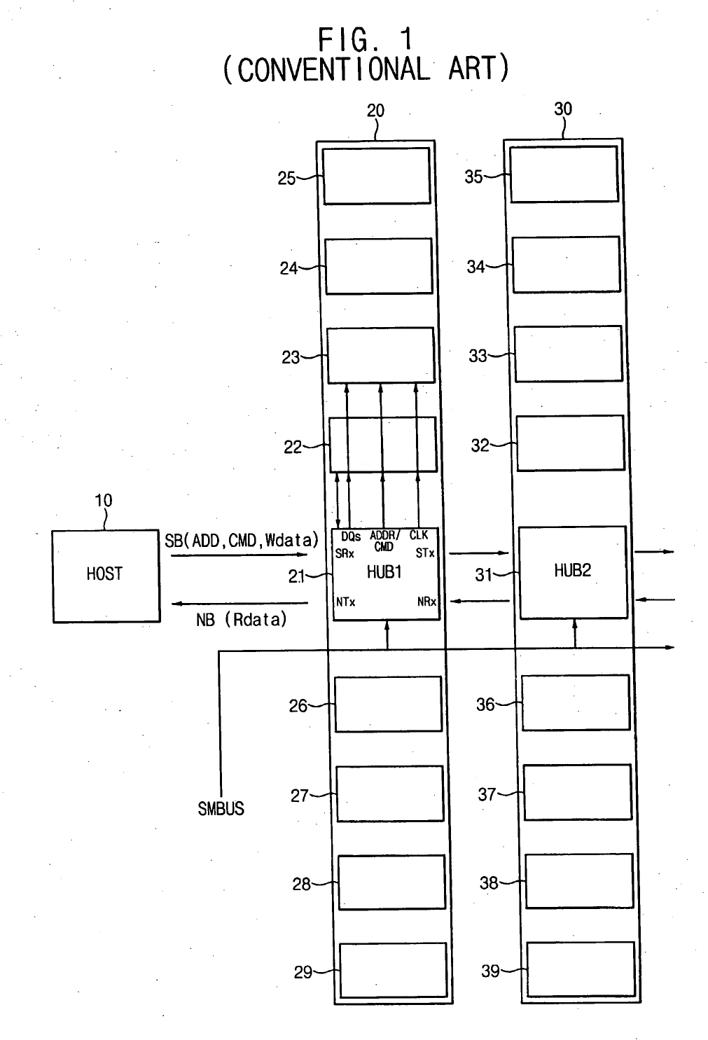

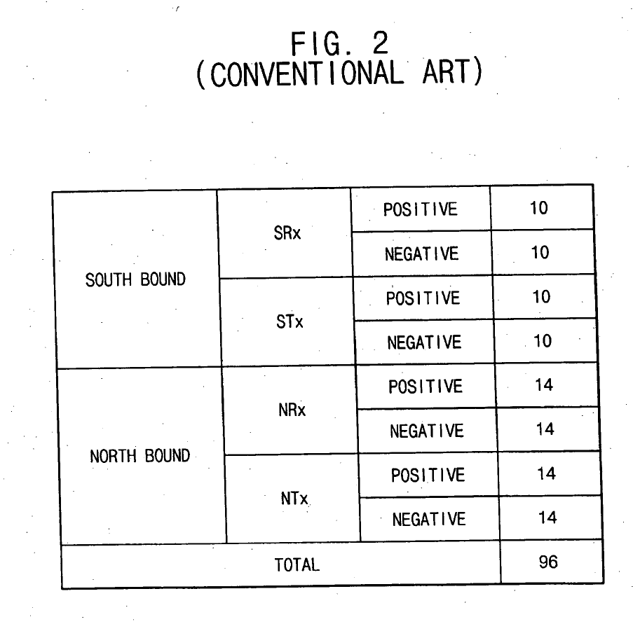

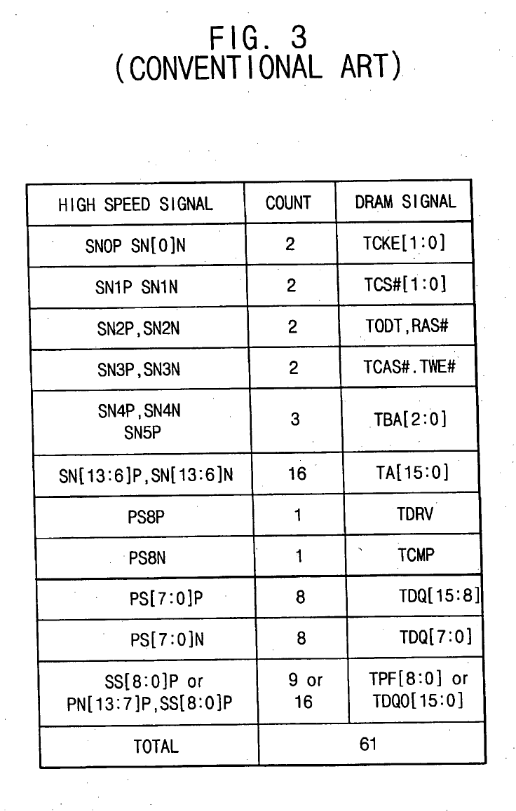

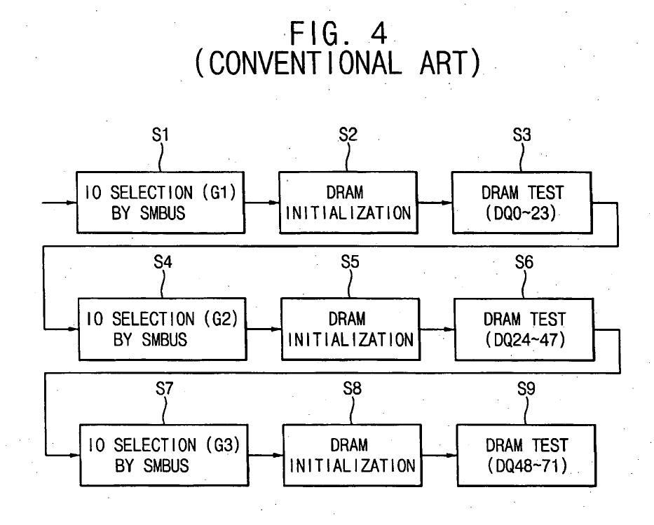

In the example embodiment of FIG. 5, structural components facilitating a “normal mode” operation of the memory module 1000 (e.g., general data read/write operations using the higher-speed southbound packet and the higher-speed northbound packet) are omitted for the sake of brevity and simplicity of description of example embodiments of the present invention. The “normal mode” of operation is described in greater detail above with respect to conventional FIGS. 1 and 2.

In the example embodiment of FIG. 5, the memory module 1000 may include a hub 100 and a plurality of dynamic random-access memory (DRAM) devices 200. In an example, the memory module 1000 may include a fully buffered DIMM (FBDIMM).

In the example embodiment of FIG. 5, the plurality of the DRAMs 200 may include 8 DRAMs for data storage and one DRAM for an error correction code (ECC), with a total of 9 DRAMs included therein. It is understood that other example embodiments of the present invention may scale to include any number of DRAMs with any number of associated ECC DRAMs. Returning to the example embodiment of FIG. 5, each of the plurality of DRAMs 200 may include 8 DQ pins and 2 DQS pins. Therefore, the plurality of the DRAMs 200 included in the memory module 1000 may have a total of 72 DQ pins and 18 DQS pins. Again, it is understood that other example embodiments of the present invention may include DRAMs with a different number of associated pins (e.g., DQ pins and/or DQS pins).

In the example embodiment of FIG. 5, the hub 100 may include a signal input unit 110, an output group selection unit 120 and a signal output unit 130. In an example, the hub 100 may be embodied by an advanced memory buffer (AMB) chip. The signal input unit 110 may receive a test signal through a higher-speed input channel. The signal input unit 110 may apply the received test signal to the plurality of the DRAMs 200.

In the example embodiment of FIG. 5, the signal input unit 110 may include a first signal input unit 111 for receiving a command signal CMD for assigning a command and an address, an address signal ADD and a clock signal CLK (e.g., to be provided to the corresponding DRAMs 200). The signal input unit 110 may further include a second signal input unit 114 for receiving a DQ test signal DQ_In and a DOS test signal DQS_In externally to be provided to the corresponding DRAMs 200.

In the example embodiment of FIG. 5, the first signal input unit 111 may include a first buffer 112 for receiving and buffering the command signal CMD and the address signal ADD. The first signal input unit 111 may be configured to provide the buffered signals to the DRAMs 200. The first signal input unit 111 may further include a second buffer 113 for receiving and buffering the clock signal CLK. The buffered clock signal CLK may be provided to the DRAMs 200.

In the example embodiment of FIG. 5, the second signal input unit 114 may include a third buffer 115 for receiving and buffering the DQS test signal DQS_In (e.g., including 18 bits) and providing the buffered test signal to the DRAMs 200. The second signal input unit 114 may further include a de-multiplexer for receiving and then de-multiplexing the DQ test signal (e.g., including 8 bits) to a test data signal (e.g., including 72 bits), and a fourth buffer 117 for providing the test data signal (e.g., including 72 bits) being outputted by the de-multiplexer to the DRAMs 200.

In the example embodiment of FIG. 5, the output group selection unit 120 may receive output data being outputted by the DRAMs 200. The output data received by the output group selection unit 120 may include the DQ signal (e.g., including 72 bits) and the DQS signal (e.g., including 18 bits) in response to the test signal applied by the signal input unit 110. The output group selection unit may select an output data group to be outputted based on a plurality of output group selection signals DQSEL0 and DQSEL1. In an example, the output data may be divided into four groups (e.g., which may thereby be referenced by the two bits of the output group selection signals DQSEL0 and DQSEL1).

In the example embodiment of FIG. 5, the output group selection signals DQSEL0 and DQSEL1 may be signals received from an external user (e.g., via test equipment). In an example, the output group selection signals DQSEL0 and DQSEL1 may collectively form a signal of 2 bits, such that, based on the 2 bit output group selection signals DQSEL0 and DQSEL1, the inputted DQ signal (e.g., including 72 bits) and DQS signal (e.g., including 18 bits) may be divided into the four groups.

For example, if the first output group selection signal DQSEL0 is set to a first logic level (e.g., a lower logic level or logic “0”) and the second output group selection signals DQSEL1 is also set to the second logic level, the DQS signals (e.g, including 18 bits) which may correspond to a first group (e.g., DQS0 through DQS17) may be selected. In another example, if the first output group selection signal DQSEL0 is set to a second logic level (e.g., a higher logic level or logic “1”) and the second output group selection signal DQSEL1 is set to the first logic level, a second group (e.g., DQ0 through DQ23) of the inputted DQ signal (e.g., including 72 bits) may be selected. In another example, if the first output group selection signal DQSEL0 is set to the first logic level and the second output group selection signal DQSEL1 is set to a second logic level (e.g., a higher logic level or logic “1”), a third group (e.g., DQ24 through DQ47) of the inputted DQ signal (e.g., including 72 bits) may be selected. In another example, if the first output group selection signal DQSEL0 and the second output group selection signal DQSEL1 are both set to the second logic level, a fourth group (e.g., DQ48 through DQ71) of the inputted DQ signal (e.g., including 72 bits) may be selected. Accordingly, because each of the four groups may include more than a bit threshold (e.g., 24 bits), an output of the entire signal may be achieved by employing a threshold number of channels (e.g., 24 channels) which correspond to output channels of the memory module 1000.

As described above in the Background of the Invention section, if the FBDIMM is subjected to the test in the transparent mode, the output DQ of the memory may not be output concurrently (e.g., in a single clock cycle) because the number of output channels of the hub may have a first number (e.g., 24) whereas the DQ pins to be tested may have a higher, second number (e.g., 72). Thus, the conventional art requires numerous testing iterations or cycles before the second number of DQ pins may be tested. However, in the example embodiment of FIG. 5, the output DQ group may be selected “on-the-fly” based on the first output group selection signal DQSEL0 and the second output group selection signal DQSEL1, thereby reducing a test time in the transparent mode.

In the example embodiment of FIG. 5, the output group selection unit 120 may be associated with an SMBUS 300 connected to an external host (not shown). The command signal CMD, the address signal ADD, the clock signal CLK, the DQ test signal DQ_In, the DQS test signal DQS_In, the first output group selection signal DQSEL0 and the second output group selection signal DQSEL1 received through the signal input unit 110 and the output group selection unit 120, respectively, may be inputted using a given number of input channels (e.g., 48 input channels) for communication of the higher-speed signal in the normal mode. In an example, the 10 positive channels and the 10 negative channels of the southbound reception port SRx and the 14 positive channels and the 14 negative channels of the northbound reception port NRx may be used as the 48 input channels.

In the example embodiment of FIG. 5, the signal output unit 130 may output an output signal DQ_Out, the output signal DQ_Out being received from the DQ group and/or the DQS group selected by the output group selection unit 120. The signal output unit 130 may include a fifth buffer 131 which may buffer the signal being received from the DQ group and/or the DQS group selected by the output group selection unit 120. The fifth buffer 131 may then output the output signal DQ_Out and/or the output signal DQS_Out.

In the example embodiment of FIG. 5, the signal output unit 130 may include, for example, 24 output channels for the communication of the higher-speed signal (e.g., including the 10 positive channels of the southbound transmission port STx and the 14 positive channels of the northbound transmission port NTx) in the normal mode. Accordingly, in an example, the output signals may be output through 24 channels.

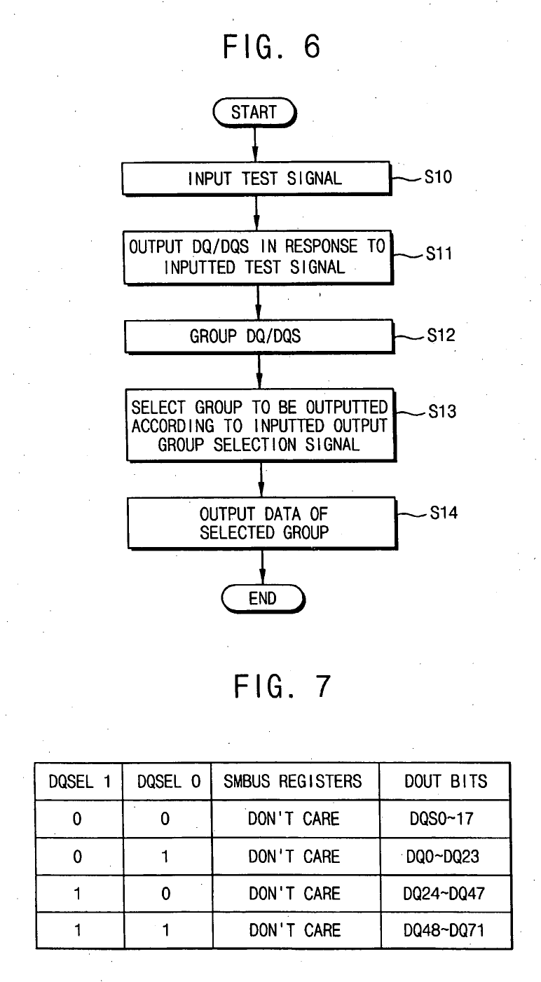

FIG. 6 is a flow chart illustrating a process for testing the memory module 1000 in accordance with another example embodiment of the present invention.

In the example embodiments of FIG. 5 and FIG. 6, the memory module 1000 may be switched to the transparent mode, and the test signal (e.g., the command signal CMD, the address signal ADD, the clock signal CLK, the DQ test signal DQ_In and the DQS test signal DQS_In) may be received (e.g., from an external source) via the 48 input channels to be applied to the DRAMs 200 included in the memory module 1000 (at S10).

In the example embodiment of FIG. 5 and FIG. 6, the DQS test signal DQS_In may include an 18-bit signal, and the test signal DQ_In may include an 8-bit signal). The inputted test signal DQ_In may be de-multiplexed into 72 bits and then applied to the DRAMs 200.

In the example embodiment of FIG. 5 and FIG. 6, the DQ signal and the DQS signal may be outputted from the DRAMs 200 in response to the inputted test signal (at S11). The output data from the DRAMs 200 (e.g., the DQ signal and the DQS signal) may be divided into four groups (e.g., each including a given number of bits) (at S12), and one of the four groups may be selected based on the output group selection signals DQSEL0 and DQSEL1 (e.g., received from an external source) (at S13).

In the example embodiment of FIG. 5 and FIG. 6, in an example, the output group selection signals DQSEL0 and DQSEL1 may be a 2-bit signal. That is, the output group selection signals DQSEL0 and DQSEL1 may include the first output group selection signal DQSEL0 as a first bit and the second output group selection signal DQSEL1 as a second bit. As discussed above, because the four groups of the inputted DQ signal (e.g., including 72-bits) and the DQS signal (e.g., including 18 bits) may be selected “on-the-fly”. It is well-known how a two bit number may select between four different selections (e.g., “00”, “01”, “10” and “11”).

FIG. 7 is a table illustrating an output group selected according to an output group selection signal according to another example embodiment of the present invention.

In the example embodiment of FIG. 7, if the first output group selection signal DQSEL0 is set to the first logic level (e.g., a lower logic level or logic “0”) and the second output group selection signals DQSEL1 is also set to the second logic level, a first group (e.g., the DQS signal including 18 bits, such as DQS0 through DQS7) may be selected. In another example, if the first output group selection signal DQSEL0 is set to the second logic level (e.g., a higher logic level or “1”) and the second output group selection signals DQSEL1 is set to the first logic level, a second group (e.g., DQ0 through DQ23 of the inputted DQ signal including 72 bits), may be selected. In another example, if the first output group selection signal DQSEL0 is set to the first logic level (e.g., a lower logic level or logic “0”) and the second output group selection signals DQSEL1 is set to the second logic level, a third group (e.g., DQ24 through DQ47 of the inputted DQ signal including 72 bits) may be selected. In another example, if the first output group selection signal DQSEL0 is set to the second logic level and the second output group selection signals DQSEL1 is also set to the second logic level, a fourth group (e.g., DQ48 through DQ71 of the inputted DQ signal including 72 bits) may be selected.

In the example embodiment of FIG. 7, the output group may be selected through the output selection (at S13), and the output DQ signal DQ_Out or the output DQS signal DQS_Out may be outputted from the selected DQ group or DQS group (at S14). An error in testing may be determined based on the output DQ signal DQ_Out or the output DQS signal DQS_Out (e.g., by comparing the value output from the DRAMs 200 with a known test value).

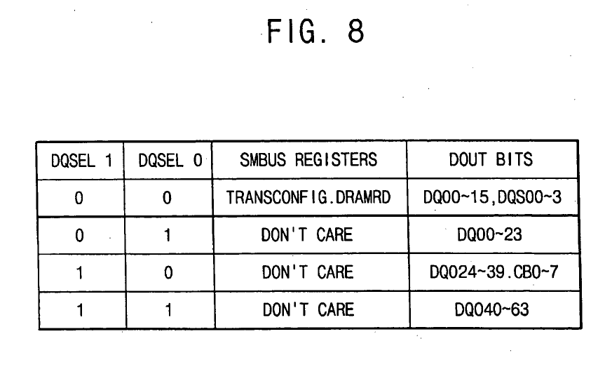

FIG. 8 is a table illustrating an output group selection based on the output group selection signals according to another example embodiment of the present invention.

In the example embodiment of FIG. 8, if a second output group selection signal DQSEL1 and a first output group selection signal DQSEL0 are set to respective first and second logic levels (e.g., “10”), respective second and first logic levels (e.g., “10”), or respective second logic levels (e.g., “11”) respectively, then the example embodiment of FIG. 8 may function equivalent to above-described example embodiments with respect to group selections.

In the example embodiment of FIG. 8, if the first output group selection signal DQSEL0 is set to the second logic level (e.g., a higher logic level or logic “1”) and the second output group selection signals DQSEL1 is set to the first logic level (e.g., a lower logic level or logic “0”), DQ0 through DQ23 of the inputted DQ signal (e.g., including 72 bits) may be selected. In another example, if the first output group selection signal DQSEL0 is set to the first logic level and the second output group selection signal DQSEL1 is set to the second logic level, DQ24 through DQ47 of the inputted DQ signal may be selected. In another example, if the first output group selection signal DQSEL0 is set to the second logic level and the second output group selection signals DQSEL1 is also set to the second logic level, DQ48 through DQ71 of the inputted DQ signal of 72 bits may be selected. Therefore, an entirety of the DQ group read from the DRAMs 200 may be outputted through 24 channels.

However, processing the DQS signal may be complicated by a number of factors, such as insufficient capacity of an output buffer. Thus, the DQ signals being output from the DRAMs 200 may be divided into three groups (e.g., as described above) and the DQS signals, namely DQS0 through DQS7, may be tested through the SMBUS (e.g., illustrated in FIG. 5) (e.g., similar to testing memory using the conventional transparent mode).

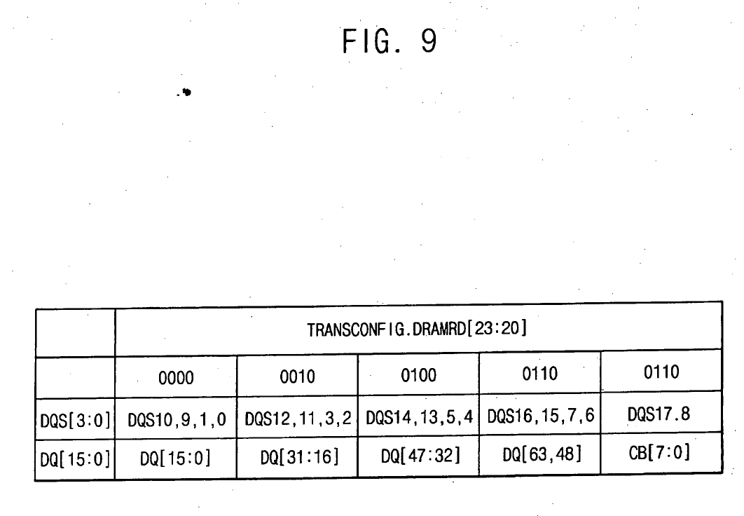

FIG. 9 is a table illustrating DQS signals tested using an SMBUS according to another example embodiment of the present invention.

In the example embodiments of FIG. 8 and FIG. 9, if the first output group selection signal DQSEL0 and the second output group selection signals DQSEL1 are both set to the first logic level (e.g., a lower logic level or logic “0”), the SMBUS may be accessed to test four of the DQS signals concurrently according to a code of bits (e.g., 4 bits) set in a register. Thus, contrary to the DQ test, multiple tests may be used because the DQ group may not be selected “on-the-fly”.

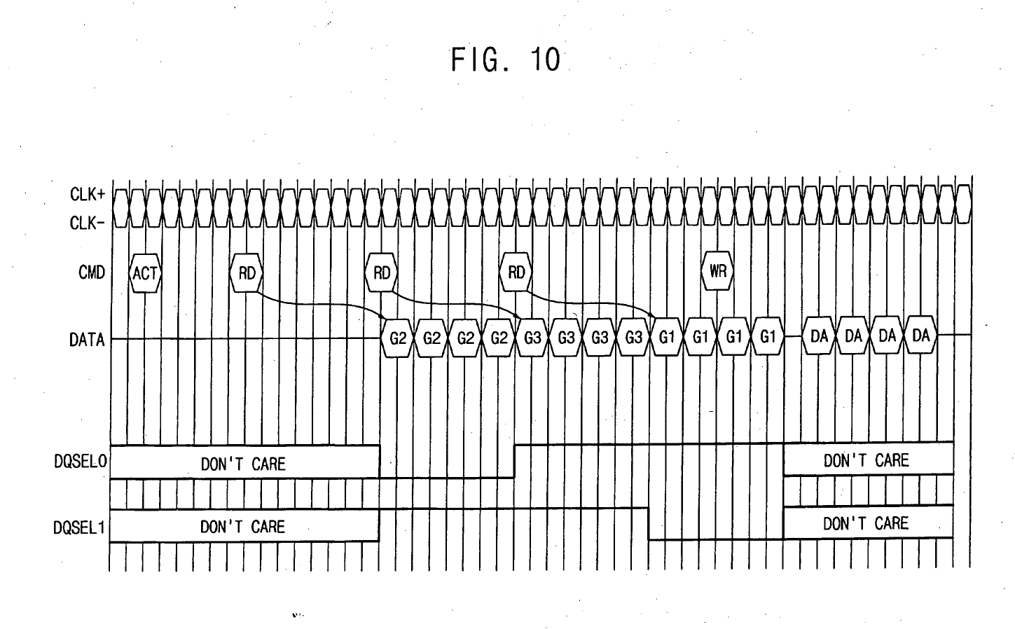

FIG. 10 is a timing diagram of signals during a memory test performed in accordance with the example embodiments of FIGS. 8 and 9.

In the example embodiment of FIG. 10, if a command signal CMD including a command to read (RD) data of the DRAM 200 is received in a state where a clock signal CLK is inputted, the data of the DQ groups selected by the output group selection signal may be output. As shown in FIG. 10, a condition where the first output group selection signal DQSEL0 and the second output group selection signals DQSEL1 are both set to the first logic level (e.g., a lower logic level or logic “0”) may not be illustrated (e.g., because such states may be included among “Don't Care” states of the timing diagram). In another example, if the first output group selection signal DQSEL0 is set to the first logic level and the second output group selection signals DQSEL1 is set to the second logic level (e.g., a higher logic level or logic “1”), a second output DQ group G2 (e.g., DQ24 through DQ47) may be output. In another example, if the first output group selection signal DQSEL0 is set to the second logic level and the second output group selection signals DQSEL1 is also set to the second logic level, a third output DQ group (e.g., DQ48 through DQ71) may be selected. In another example, if the first output group selection signal DQSEL0 is set to the second logic level and the second output group selection signals DQSEL1 is set to the first logic level, a first output DQ group G1 (e.g., DQ0 through DQ23) may be selected.

Accordingly, as shown in the example embodiment of FIG. 10, a test time delay occurring due to an insufficient number of available output channels during a transparent mode test may be reduced through the use of an external output group selection signal. In another example embodiment of the present invention, one of a plurality of DQ groups may be selected for output “on-the-fly” using the external output group selection signal during a transparent mode test, thereby reducing the delay of an associated test time with an SMBUS.

Example embodiments of the present invention being thus described, it will be obvious that the same may be varied in many ways. For example, it is understood that the above-described first and second logic levels may correspond to a lower level and a higher logic level, respectively, in an example embodiment of the present invention. Alternatively, the first and second logic levels/states may correspond to the higher logic level and the lower logic level, respectively, in other example embodiments of the present invention.

Further, above-described example embodiments of the present invention are described with references to a particular pin configuration of a memory device (e.g., 72 DQ pins, four groups of selectable DQ/DQS pins, 24 available output channels, etc.). However, it is understood that other example embodiments of the present invention may be directed to a memory device with any number of pins, with the pins including any number of selectable groups. Thus, while two selection signals are used above to select between four groups of pins, it will be readily apparent to one of ordinary skill in the art of digital logic that three selection signals may be used to select among eight groups of pins, and so on, such that the number of pins and groups may scale based on the particular memory device to be tested.

Such variations are not to be regarded as a departure from the spirit and scope of example embodiments of the present invention, and all such modifications as would be obvious to one skilled in the art are intended to be included within the scope of the following claims.

What is claimed is:

1. A memory module, comprising:
a plurality of memory chips; and
a hub applying a test signal to the plurality of memory chips included in the memory module, receiving output data from the plurality of memory chips in response to the applied test signal, dividing the output data into a plurality of groups, selecting at least one of the plurality of groups in response to an output group selection signal and outputting the at least one selected group.

2. The method of claim 1, wherein the test signal is received at the hub from an external device.

3. The method of claim 1, wherein the output group selection signal is received at the hub from an external device.

4. The memory module of claim 1, wherein the hub includes:
a signal input unit configured to receive the test signal from an external device, and configured to apply the received test signal to the plurality of memory chips;
an output group selection unit configured to divide the plurality of the output data into the plurality of groups in response to the applied test signal, and configured to select the at least one selected group in response to the output group selection signal; and
a signal output unit configured to output the at least one selected group

5. The memory module of claim 4, wherein the signal input unit includes:
a first signal input unit configured to receive a command signal, an address signal and a clock signal from the external device, and configured to provide the command signal, the address signal and the clock signal to the plurality of memory chips; and
a second signal input unit configured to receive a DQ test signal and a DQS test signal, and to provide the DQ test signal and the DQS test signal to the plurality of memory chips, the DQ test signal and the DQS test signal being included in the test signal.

6. The memory module of claim 5, wherein the first signal input unit includes:
a first buffer configured to receive and buffer the command signal and the address signal, and configured to provide the command signal and the address signal to the plurality of memory chips; and
a second buffer configured to receive and buffer the clock signal, and configured to provide the clock signal to the plurality of memory chips.

7. The memory module of claim 5, wherein the second signal input unit includes:
a first buffer configured to receive and buffer the DQS test signal, and configured to provide the DQS test signal to the plurality of memory chips;
a de-multiplexer configured to receive the DQ test signal, and configured to de-multiplex the DQ test signal based on the address signal; and
a second buffer configured to provide the de-multiplexed test signal to the plurality of memory chips.

8. The memory module of claim 4, wherein the signal output unit includes a buffer configured to buffer and the at least one group selected by the output group selection unit.

9. The memory module of 1, wherein the hub includes an advanced memory buffer (AMB).

10. The memory module of claim 1, wherein the memory module includes a fully buffered dual inline memory module (FBDIMM).

11. The memory module of claim 1, wherein the memory module includes a dynamic random-access memory (DRAM).

12. The memory module of claim 1, wherein the plurality of groups numbers 4, a number of input channels through which the test signal is received numbers 48, and a number of output channels through which the at least one selected group is output numbers 24.

13. The memory module of claim 1, wherein the output group selection signal is a 2-bit signal.

14. The memory module of claim 1, wherein each of the plurality of groups includes a number of bits equal to a number of output channels through which the at least one selected group is output.

15. The memory module of claim 1, wherein the output group selection signal is received from an external device through an input channel.

16. The memory module of claim 1, wherein the at least one selected group is output through an output channel, the output channel including at least one channel for outputting higher-speed signals during a normal operation mode.

17. The memory module of claim 16, wherein the output channel includes 10 positive channels corresponding to a southbound transmission port, and 14 negative channels corresponding to a northbound transmission port.

18. The memory module of claim 1, wherein the test signal is received through an input channel, the input channel including at least one channel for receiving a higher-speed signal during a normal operation mode.

19. The memory module of claim 18, wherein the input channel includes 10 positive channels and 10 negative channels corresponding to a southbound transmission port, and 14 positive channels and 14 negative channels corresponding to a northbound transmission port.

20. The memory module of claim 1, wherein the plurality of the memory chips includes nine memory chips.

21. The memory module of claim 20, wherein the output data received from the plurality of memory chips includes an output DQ signal with 72 bits and an output DQS signal with 18 bits.

22. The memory module of claim 4, wherein the output group selection unit is associated with an external System Management Bus (SMBUS).

23. The memory module of claim 22, wherein at least a portion of one or more of the plurality of groups is tested with the SMBUS in response to the output group selection signal.

24. A method for testing a memory module, comprising:
applying a test signal to a plurality of memory chips included in the memory module;
receiving output data from the plurality of memory chips in response to the applied test signal;
dividing the output data into a plurality of groups;
selecting at least one of the plurality of groups in response to an output group selection signal; and
outputting the at least one selected group.

25. The method of claim 24, wherein the test signal is received from an external device.

26. The method of claim 24, wherein the output group selection signal is received from an external device.

27. The method of claim 24, wherein the at least one selected group is outputted through at least one output channel.

28. The method of claim 24, wherein the test signal includes a command signal, an address signal, a clock signal, a DQ test signal and a DQS test signal.

29. The method of claim 27, wherein applying the test signal to the plurality of the memory chips includes de-multiplexing the DQ test signal to provide a de-multiplexed test signal to the plurality of memory chips.

30. The method of claim 25, wherein the plurality of groups numbers 4, a number of input channels through which the test signal is received numbers 48, and a number of output channels through which the at least one selected group is output numbers 24.

31. The method of claim 24, wherein the output group selection signal is a 2-bit signal.

32. A method for testing the memory module of claim 1.
